(19) United States
(12) Patent Application Publication
(10) Pub. No.: US 2021/0273828 A1
(43) Pub. Date: Sep. 2, 2021

(54) COMMUNICATION CONTROL DEVICE, MEDIA TRANSMISSION METHOD, AND MEDIA TRANSMISSION PROGRAM

(71) Applicant: Nippon Telegraph and Telephone Corporation, Tokyo (JP)

(72) Inventor: Ichiro Hirao, Musashino-shi, Tokyo (JP)

(21) Appl. No.: 17/049,615

(22) PCT Filed: Apr. 19, 2019
(86) PCT No.: PCT/JP2019/016809

§ 371 Date: Oct. 22, 2020

(30) Foreign Application Priority Data
Apr. 24, 2018 (JP) 2018-083159

(51) Int. Cl. H04L 12/66; H04L 1/16; H04L 29/06

(52) U.S. Cl. CPC H04L 12/66; H04L 65/1006; H04L 1/1607

(57) ABSTRACT

To enable delivery of media in an early state between telecommunications carriers that are different in support status of a provisional response delivery acknowledgement procedure. A communication control device 1 of a first carrier provided at a boundary to a second-carrier network includes: a transmission unit 11 that adds, to a provisional response, a parameter that indicates that a provisional response delivery acknowledgement procedure is applied, and transmits the provisional response to the second-carrier network; a response unit 12 that transmits a success response in response to a message in the provisional response delivery acknowledgement procedure transmitted from the second-carrier network; and a media control unit 13 that delivers media delivered from a media server to the second-carrier network in an early state.

### TECHNICAL FIELD

The present invention relates to a communication control device that delivers media to a network of another carrier, a media delivery method, and a media delivery program.

### BACKGROUND ART

In recent years, various investigations have been carried out on the IP interconnection between telecommunications carriers. In Non-Patent Literature 1, various regulations concerning the IP interconnection between telecommunications carriers are described. Non-Patent Literature 1 also states that it is essential to apply the PRACK procedure (100rel/PRACK procedure) described in Non-Patent Literature 2. In Non-Patent Literature 2, a PRACK procedure for providing a reliable provisional response in SIP is described.

### CITATION LIST

### Non-Patent Literature

Non-Patent Literature 1: 3GPP, TS 29.165, “Inter-IMS Network to Network Interface (NNI)”
Non-Patent Literature 2: IETF, RFC3262, “Reliability of Provisional Responses in the Session Initiation Protocol (SIP)”

### SUMMARY OF THE INVENTION

### Technical Problem

Voice call services provided by telecommunications carriers include a service of previously notifying information about the service (such as service fee) to an originator by delivering pre-connection guidance to the originator in an early state when the call is yet to be established in providing a service.

In Non-Patent Literature 2, the provisional response delivery acknowledgement procedure (PRACK procedure) using 100rel/PRACK is defined as a standard SIP call control procedure used when delivering media in the early state. However, the support status of the PRACK procedure of the servers and terminals in the network varies between the networks of telecommunications carriers.

A service offered in a closed IP network of a first carrier can be provided irrespective of whether the network supports the PRACK procedure or not.

However, a service provided between a plurality of telecommunications carriers by IP network interconnection has a problem that media cannot be delivered in the early state if the IP network of one of the telecommunications carriers that are connecting to each other does not support the PRACK procedure and the IP network of the other telecommunications carrier makes it an essential requirement to support the PRACK procedure.

Specifically, the IP network that makes it an essential requirement to support the PRACK procedure does not communicate any media unless the steps defined by the PRACK procedure are carried out. Therefore, the IP network that does not support the PRACK procedure, which is designed to start transmission and reception of media without carrying out the step defined by the PRACK procedure, cannot deliver any media in the early state to the IP network that supports the PRACK procedure.

The present invention has been devised in view of the circumstances described above, and an object of the present invention is to enable delivery of media in an early state between telecommunications carriers that are different in support status of a provisional response delivery acknowledgement procedure.

### Means for Solving the Problem

To attain the object described above, the present invention provides a communication control device of a first carrier provided at a boundary to a second-carrier network, the communication control device includes: a transmission unit that adds, to a provisional response, a parameter that indicates that a provisional response delivery acknowledgement procedure is applied, and transmits the provisional response to the second-carrier network; a response unit that transmits a success response in response to a message in the provisional response delivery acknowledgement procedure transmitted from the second-carrier network; and a media control unit that delivers media delivered from a media server to the second-carrier network in an early state.

The present invention also provides a media delivery method performed by a communication control device of a first carrier provided at a boundary to a second-carrier network, the media delivery method includes: a transmission step of adding, to a provisional response, a parameter that indicates that a provisional response delivery acknowledgement procedure is applied, and transmitting the provisional response to the second-carrier network; a response step of transmitting a success response in response to a message in the provisional response delivery acknowledgement procedure transmitted from the second-carrier network; and a media control step of delivering media delivered from a media server to the second-carrier network in an early state.

The present invention also provides a media delivery program that makes a computer function as the communication control device described above.

### Effects of the Invention

According to the present invention, media can be delivered in an early state between telecommunications carriers that are different in support status of a provisional response delivery acknowledgement procedure.

### BRIEF DESCRIPTION OF DRAWINGS

FIG. 1 is a diagram showing a general configuration of a communication system according to an embodiment of the present invention.

FIG. 2 is a functional block diagram showing a configuration of a first-carrier NNI-GW.

FIG. 3 is a sequence diagram showing an early media delivery process.

### DESCRIPTION OF EMBODIMENTS

In the following, an embodiment of the present invention will be described with reference to the drawings.

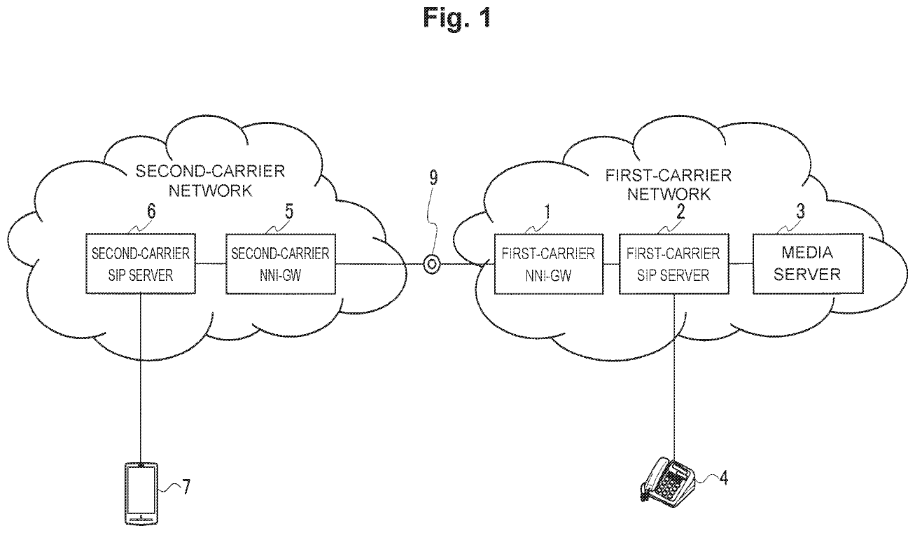

FIG. 1 is a system configuration diagram showing the whole of a communication system according to an embodiment of the present invention. The communication system shown in the drawing is a system in which IP interconnections occur between different telecommunications carriers

In the communication system according to this embodiment, a first-carrier network of a telecommunications carrier A, which is referred to also as a first carrier, and a second-carrier network of a telecommunications carrier B, which is referred to also as a second carrier, are connected to each other via a point of interface (POI) 9. The first-carrier network and the second-carrier network are IP networks.

The first-carrier network shown in the drawing includes a first-carrier network to network interface gateway (NNI-GW) 1, a first-carrier SIP server 2, and a media server 3. The first-carrier NNI-GW 1 is a gateway provided at a POI boundary to the second-carrier network. The first-carrier NNI-GW 1 converts data format, communication mode or the like to connect the first-carrier network and the second-carrier network to each other. The first-carrier SIP server 2 performs a call processing (call control) such as origination or reception. A first-carrier terminal 4 is connected to the first-carrier SIP server 2. The first-carrier terminal 4 is a terminal having a telephone function and may be a SIP terminal, for example. In the example shown in the drawing, the first-carrier terminal 4 is a landline telephone.

The media server 3 is a server that provides media such as audio or video. In this embodiment, the media server 3 delivers (transmits) early media. The early media is media transmitted or received in an early state when a call is yet to be established (a SIP session is yet to be established). The early media is used to previously notify the originator of various kinds of guidance, such as service fee, when the call is yet to be established, for example. In this embodiment, the media server 3 delivers early media (pre-connection guidance) in response to a request from the first-carrier SIP server 2.

The second-carrier network is connected to the first-carrier network (first-carrier NNI-GW 1) via the POI 9. The second-carrier network shown in the drawing includes a second-carrier NNI-GW 5 and a second-carrier SIP server 6. The second-carrier NNI-GW 5 is a gateway provided at the POI boundary to the first-carrier network. The second-carrier NNI-GW 5 converts data format, communication mode or the like to connect the two networks to each other. The second-carrier SIP server 6 performs a call processing such as origination or reception. A second-carrier terminal 7 is connected to the second-carrier SIP server 6. The second-carrier terminal 7 is a terminal having a telephone function and may be a SIP terminal, for example. In the example shown in the drawing, the second-carrier terminal 7 is a mobile terminal such as a smartphone.

In the communication system shown in FIG. 1, the NNI-GWs 1 and 5 are separate from the SIP servers 2 and 6, respectively. However, the SIP servers 2 and 6 may have functions of the NNI-GWs 1 and 5, respectively.

The second-carrier network in this embodiment is a mobile network provided by a mobile network operator, and the first-carrier network in this embodiment is a landline telephone network provided by a fixed network operator.

The mobile network operator of the second-carrier network adopts 3GPP and applies and implements (supports) the PRACK procedure in Non-Patent Literature 2, which is described as essential in Non-Patent Literature 1, in the servers 5 and 6 in the second-carrier network and the second-carrier terminal 7. The PRACK procedure (100rel/PRACK procedure) is a provisional response delivery acknowledgement procedure for providing a reliable provisional response (18x response).

On the other hand, the fixed network operator of the first-carrier network has no such regulations concerning the application of the PRACK procedure as in 3GPP from the viewpoint of the interconnection between IP networks. Therefore, the first-carrier network in this embodiment does not apply and implement (support) the PRACK procedure in the servers 1 to 3 in the first-carrier network and the first-carrier terminal 4.

In this embodiment, when transmission and reception of early media occurs between the first-carrier network (first network) that does not support the PRACK procedure and the second-carrier network (second network) that supports the PRACK procedure, the first-carrier NNI-GW 1 of the first-carrier network that does not support the PRACK procedure accommodates the difference in processing relating to the PRACK procedure between the first-carrier network and the second-carrier network.

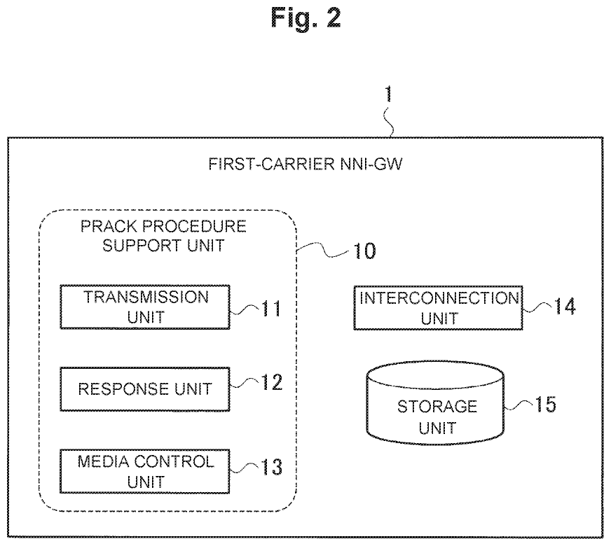

FIG. 2 is a functional block diagram showing a configuration of the first-carrier NNI-GW 1 (communication control device) of the first-carrier network according to this embodiment. The first-carrier NNI-GW 1 according to this embodiment is an NNI-GW on the side of the first-carrier network that does not support the PRACK procedure.

The first-carrier NNI-GW 1 shown in the drawing includes a PRACK procedure support unit 10, an interconnection unit 14 and a storage unit 15. The PRACK procedure support unit 10 includes a transmission unit 11, a response unit 12 and a media control unit 13. The transmission unit 11 adds, to a provisional response (18x response), a parameter (require: 100rel) that indicates that the PRACK procedure (provisional response delivery acknowledgement procedure) is applied, and transmits the provisional response to the second-carrier network. The transmission unit 11 also adds, to the provisional response, a header (P-Early-Media) that indicates media be transmitted in the early state, and transmits the provisional response to the second-carrier network.

The response unit 12 transmits a success response in response to a message in the PRACK procedure transmitted from the second-carrier network. The media control unit 13 delivers media (early media) delivered from the media server 3 to the second-carrier network in the early state when a call is yet to be established. For example, the media control unit 13 delivers media to the second-carrier network after receiving an UPDATE message in the PRACK procedure.

The interconnection unit 14 converts data format, communication mode or the like to transmit and receive data to and from the second-carrier network. The storage unit 15 stores media transmitted from the media server 3.

The first-carrier NNI-GW 1 described above may be a general-purpose computer system that includes a central processing unit (CPU, processor), a memory, a storage (hard disk drive (HDD), solid state drive (SSD)), a communication device, an input device and an output device. In the computer system, the CPU executes a program for the first-carrier NNI-GW 1 loaded onto the memory, thereby implementing the functions of the first-carrier NNI-GW 1. The program for the first-carrier NNI-GW 1 may be stored in a computer readable recording medium, such as an HDD, an SSD, a USB memory, a CD-ROM, a DVD-ROM or an MO, or may be distributed over a network.

Next, an operation of the communication system according to this embodiment will be described.

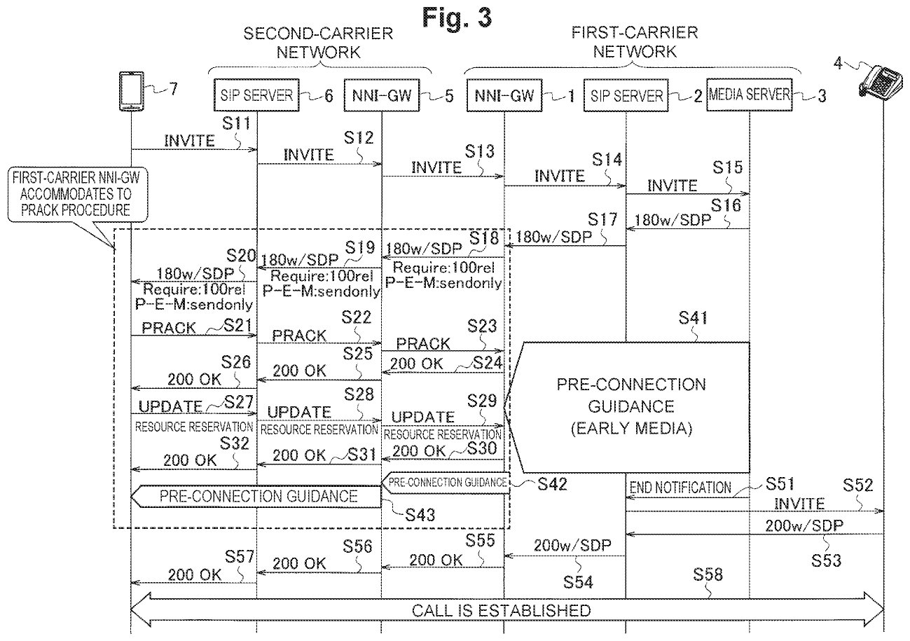

FIG. 3 is a sequence diagram showing an early media transmission process. In early media delivery, the second-carrier network supports the PRACK procedure, and the first-carrier network does not support the PRACK procedure. In this embodiment, when interconnecting the IP networks that are different in support status of the PRACK procedure, the first-carrier NNI-GW 1 on the network that does not support the PRACK procedure accommodates to the PRACK procedure to deliver early media to the second-carrier network in which the PRACK procedure is essential.

When the second-carrier terminal 7 (originator terminal) originates a call to the first-carrier terminal 4 (recipient terminal), the second-carrier terminal 7 transmits an INVITE message (session establishment request) to the second-carrier network (the second-carrier SIP server 6 and the second-carrier NNI-GW 5), and the second-carrier network transmits the INVITE message to the first-carrier network (S11 to S13).

The first-carrier NNI-GW 1 (interconnection unit 14) of the first-carrier network transmits the INVITE message received from the second-carrier network to the first-carrier SIP server 2 (S14). The first-carrier SIP server 2 transmits the received INVITE message to the media server 3 (S15), in order to transmit early media under a service condition specified in the INVITE message.

In response to receiving the INVITE message, the media server 3 transmits an 18x response (provisional response) to the first-carrier SIP server 2 (S16). In this example, the media server 3 transmits 180w/SDP as the 18x response to the first-carrier SIP server 2. 180w/SDP is a provisional response that indicates “180: calling” with session description protocol (SDP) information added thereto. Since the first-carrier network does not support the PRACK procedure, a parameter “require: 100rel”, which indicates that the PRACK procedure is applied, is not set in the 18x response transmitted by the media server 3.

After transmitting the 18x response, the media server 3 delivers (transmits) early media to the first-carrier NNI-GW 1 via the first-carrier SIP server 2 (S41). In the example shown in the drawing, the early media is pre-connection guidance that previously notifies the originator of service fee or the like in the early state when the call is yet to be established. However, the early media is not limited to the pre-connection guidance.

The first-carrier SIP server 2 transmits the 18x response transmitted from the media server 3 to the first-carrier NNI-GW 1 (S17). The first-carrier NNI-GW 1 (interconnection unit 14) receives the 18x response.

The first-carrier NNI-GW 1 then performs a process that corresponds to the PRACK procedure shown in S18 to S44. In the PRACK procedure, acknowledgement of delivery of the 18x response by a PRACK message is performed, acknowledgement of reserve of a resource by an UPDATE message is performed, and then communication of media is performed. Therefore, the first-carrier NNI-GW 1 accommodates to the PRACK procedure by performing the process described below.

The first-carrier NNI-GW 1 (transmission unit 11) adds the parameter “require: 100rel” to the received 18x response in order to match with the PRACK procedure in the second-carrier network, before transmitting the 18x response to the second-carrier network (S18). The parameter “require: 100rel” is a parameter that indicates that the PRACK procedure is applied. More specifically, the parameter “require: 100rel” is a parameter that indicates acknowledgement of delivery of a provisional response by a PRACK message must be supported in a call connection between IP networks.

The first-carrier NNI-GW 1 (transmission unit 11) also adds the header “P-Early-Media” that indicates that early media is delivered, to the 18x response. In 3GPP (TS 24.628) and TTC (jj-90.30), it is prescribed that the header “P-Early-Media” be set in the 18x response when early media is delivered by IP interconnection to a network of another carrier. In this example, the first-carrier NNI-GW 1 (transmission unit 11) sets in the header “P-Early-Media” a parameter “sendonly” that indicates that early media is delivered in only one direction from the first-carrier network (recipient-side network) to the second-carrier network (originator-side network).

The first-carrier NNI-GW 1 continues delivering the 18x response until the first-carrier NNI-GW 1 receives a PRACK message according to the PRACK procedure.

The second-carrier NNI-GW 5 of the second-carrier network receives the 18x response with the parameter “require: 100rel” and the header “P-Early-Media” added thereto, and transmits the 18x response to the second-carrier terminal 7 via the second-carrier SIP server 6 (S19, S20).

In response to receiving the 18x response, the second-carrier terminal 7 transmits a PRACK message to the first-carrier network via the second-carrier network (the second-carrier SIP server 6 and the second-carrier NNI-GW 5) according to the PRACK procedure (S21 to S23).

In response to receiving the PRACK message, the first-carrier NNI-GW 1 (response unit 12) of the first-carrier network transmits a 200 OK response (success response) to the second-carrier network according to the PRACK procedure (S24). The second-carrier NNI-GW 5 of the second-carrier network transmits the received 200 OK response to the second-carrier terminal 7 via the second-carrier SIP server 6 (S25, S26).

In response to receiving the 200 OK response, the second-carrier terminal 7 transmits an UPDATE message for reserving a resource for early media delivery to the first-carrier network via the second-carrier network (the second-carrier SIP server 6 and the second-carrier NNI-GW 5) according to the PRACK procedure (S27 to S29).

In response to receiving the UPDATE message, the first-carrier NNI-GW 1 (response unit 12) of the first-carrier network transmits the 200 OK response to the second-carrier network according to the PRACK procedure (S30). The second-carrier NNI-GW 5 transmits the received 200 OK response to the second-carrier terminal 7 via the second-carrier SIP server 6 (S31, S32).

After receiving the UPDATE message, the first-carrier NNI-GW 1 (media control unit 13) also delivers early media (audio packet) delivered from the media server 3 to the second-carrier network (S42). The media server 3 delivers the early media to the first-carrier NNI-GW 1 via the first-carrier SIP server 2 (S41) after transmitting the 18x response (S16).

Specifically, even if the first-carrier NNI-GW 1 (media control unit 13) receives early media before receiving an UPDATE message, the first-carrier NNI-GW 1 (media control unit 13) waits for the UPDATE message before delivering the early media to the second-carrier network or, in other words, the first-carrier NNI-GW 1 (media control unit 13) delivers the early media in response to receiving the UPDATE message. For example, the first-carrier NNI-GW 1 (media control unit 13) retains the early media delivered from the media server 3 in the first-carrier NNI-GW 1 by temporarily storing the early media in the storage unit 15 (memory), for example, and delivers the retained early media to the second-carrier network in response to receiving the UPDATE message.

The second-carrier NNI-GW 5 of the second-carrier network receives the early media delivered from the first-carrier NNI-GW 1, and delivers the early media to the second-carrier terminal 7 (S43).

The second-carrier terminal 7 receives and reproduces the early media. In this way, the originator on the second-carrier terminal 7 can hear the early media, such as pre-connection guidance that notifies service fee or the like, in the early state when the call is yet to be established.

When the delivery of the early media in S41 is completed, the media server 3 transmits an end notification message to the first-carrier SIP server 2 (S51). In response, the first-carrier SIP server 2 transmits an INVITE message to the first-carrier terminal 4 (S52). In response to receiving the INVITE message, the first-carrier terminal 4 transmits a 200 OK response (200w/SDP) to the first-carrier SIP server 2 (S53).

The first-carrier SIP server 2 transmits the received 200 OK response to the first-carrier NNI-GW 1 (S54). The first-carrier NNI-GW 1 transmits the received 200 OK response to the second-carrier network (S55). The second-carrier NNI-GW 5 of the second-carrier network transmits the received 200 OK response to the second-carrier terminal 7 via the second-carrier SIP server 6 (S56, S57).

In this way, a SIP session, and thus a call, is established between the second-carrier terminal 7 and the first-carrier terminal 4 (S58).

In this embodiment described so far, the first-carrier NNI-GW 1 includes the transmission unit 11 that adds, to a provisional response, a parameter that indicates that the PRACK procedure (provisional response delivery acknowledgement procedure) is applied, and transmits the provisional response to the second-carrier network, the response unit 12 that transmits a success response in response to a message in the PRACK procedure transmitted from the second-carrier network, and the media control unit 13 that delivers media delivered from the media server 3 to the second-carrier network in the early state.

In this way, according to this embodiment, the first-carrier NNI-GW 1 arranged in the first-carrier network that does not support the PRACK procedure accommodates the operations involved with the PRACK procedure, thereby allowing early media to be delivered (transmitted and received) between the first-carrier network and the second-carrier network that are different in support status of the PRACK procedure.

It can also be contemplated that the NNI-GW does not support the PRACK procedure, and the SIP server and terminals in the IP network that does not support the PRACK procedure support the PRACK procedure. In that case, however, such a SIP server and terminals need to be developed and implemented, and such development and implementation are more complicated.

To the contrary, according to this embodiment, the NNI-GW provided at the boundary to the second-carrier network accommodates the difference in PRACK procedure. Therefore, according to this embodiment, delivery of early media in a call for connection to the second-carrier network that supports the PRACK procedure can be enabled by a local modification rather than modifications to the processes of the servers (the SIP server and the media server) in the network and the processes of the terminals in the network.

In addition, according to this embodiment, since the NNI-GW accommodates the difference in PRACK procedure, the NNI-GW can determine whether accommodation to the PRACK procedure is necessary or not based on whether the second-carrier network supports the PRACK procedure or not. That is, the NNI-GW has to accommodate to the PRACK procedure only when the NNI-GW is connecting to a network of another carrier (telecommunications carrier) that supports the PRACK procedure.

Note that the present invention is not limited to the embodiment described above, and various modifications can be made without departing from the spirit of the present invention.

### REFERENCE SIGNS LIST

1 First-carrier NNI-GW
11 Transmission unit
12 Response unit
13 Media control unit
14 Interconnection unit
15 Storage unit
2 First-carrier SIP server
3 Media server
4 First-carrier terminal
5 Second-carrier NNI-GW
6 Second-carrier SIP server
7 Second-carrier terminal
9 POI

1. A communication control device of a first carrier provided at a boundary to a second-carrier network, the communication control device comprising:
a transmission unit configured to add, to a provisional response, a parameter indicating that a provisional response delivery acknowledgement procedure is applied, and transmit the provisional response to the second-carrier network;
a response unit configured to transmit a success response in response to a message in the provisional response delivery acknowledgement procedure transmitted from the second-carrier network; and
a media control unit configured to deliver, to the second-carrier network, media delivered from a media server in an early state.

2. The communication control device according to claim 1, wherein the media control unit is configured to deliver the media to the second-carrier network after receiving an UPDATE message in the provisional response delivery acknowledgement procedure.

3. The communication control device according to claim 1, wherein the transmission unit is configured to add, to the provisional response, a header indicating that the media is delivered in the early state, and transmit, to the second-carrier network, the provisional response.

4. A media delivery method performed by a communication control device of a first carrier provided at a boundary to a second-carrier network, the media delivery method comprising:
adding, to a provisional response, a parameter indicating that a provisional response delivery acknowledgement procedure is applied;
transmitting the provisional response to the second-carrier network;
transmitting a success response in response to a message in the provisional response delivery acknowledgement procedure transmitted from the second-carrier network; and
delivering, to the second-carrier network, media delivered from a media server in an early state.

5. The media delivery method according to claim 4, wherein the media is delivered to the second-carrier network after an UPDATE message in the provisional response delivery acknowledgement procedure is received.

6. The media delivery method according to claim 4, wherein a header indicating that the media is delivered in the early state is added to the provisional response, and the provisional response is delivered to the second-carrier network.

7. A recording medium storing a media delivery program, wherein executing of the media delivery program causes one or more computers to perform operations comprising:
adding, to a provisional response, a parameter indicating that a provisional response delivery acknowledgement procedure is applied;
transmitting the provisional response to a second-carrier network;
transmitting a success response in response to a message in the provisional response delivery acknowledgement procedure transmitted from the second-carrier network; and
delivering, to the second-carrier network, media delivered from a media server in an early state.

8. The recording medium according to claim 7, wherein the media is delivered to the second-carrier network after an UPDATE message in the provisional response delivery acknowledgement procedure is received.

9. The recording medium according to claim 7, wherein a header indicating that the media is delivered in the early state is added to the provisional response, and the provisional response is delivered to the second-carrier network.
